(19) United States
(12) Patent Application Publication
(10) Pub. No.: US 2024/0138446 A1
(43) Pub. Date: May 2, 2024

(54) FOOD PRESERVATION SYSTEM

(71) Applicants: Bruce B. ROESNER, Banner Elk, NC (US); GreenLifeTech Corp., Banner Elk, NC (US)

(72) Inventor: Bruce B. Roesner, Banner Elk, NC (US)

(21) Appl. No.: 18/273,699

(22) PCT Filed: Jan. 21, 2022
(86) PCT No.: PCT/US2022/013419

§ 371 Date: Jul. 21, 2023

Related U.S. Application Data
(60) Provisional application No. 63/140,144, filed on Jan. 21, 2021.

(51) Int. Cl. A23L 3/28; A23L 3/3436

(52) U.S. Cl. CPC A23L 3/28; A23L 3/3436

(57) ABSTRACT

In some implementations, a system for removing oxygen from a container includes a recirculation pump, an oxygen removal device, and an anti-bacterial system. The recirculation pump includes an intake and a discharge, and the intake includes a first connector. The discharge is fluidically connected to an oxygen removal device. The anti-bacterial destroys bacteria through introducing of UV light or ozone.

### CLAIM OF PRIORITY

This application claims priority to U.S. Provisional Application No. 63/140,144, filed on Jan. 21, 2021, the entire contents of which are incorporated by reference in its entirety.

### TECHNICAL FIELD

This invention relates to food preservation.

### BACKGROUND

Oxygen can be removed from a container in which fruits and vegetables are stored in order to extend their shelf lives. Not only does this process reduce ripening of the produce but it also greatly reduces the growth of aerobic bacteria, (bacteria requiring oxygen to grow). However, anaerobic bacteria (grow in oxygen free environments) such as botulism and listeria can continue their growth and actually prefer an oxygen deprived environment. Although these types of bacteria are rare, they can make humans quite ill, and in some cases cause death, especially to children and pregnant women. Also, aerobic bacteria will again grow once the oxygen is reintroduced.

Some bacteria when subjected to changes in their environment, such as oxygen levels, can produce spores, which when again exposed to a conducive environment will become active as full-blown bacteria. Although the bacteria might be destroyed, these spores in some cases can withstand up to four hours in boiling water. Therefore, it is advantageous to destroy the bacteria from the onset.

### SUMMARY

In some implementations, a system for removing oxygen from a container includes a recirculation pump, an oxygen removal device, and an anti-bacterial system. The recirculation pump includes an intake and a discharge. The oxygen removal device receives the discharge and then injected into the container. The anti-bacterial destroys bacteria through introducing UV light or ozone in the system.

The disinfectant enhancement of the present disclosure offers advantages over the previous oxygen deprived system. As described, it has the distinct advantage of significantly reducing the number of or destroying bacteria, both aerobic and anaerobic, prior to or during the food preservation process. The ozone (O₃) generation described is of particular commercial value due to its ease of generation, potency in destroying bacteria, and environmental friendliness. The combination of the oxygen deprivation and bacteria destruction will further enhance the shelf life of vegetables and fruit or other organic material.

This system could be delivered along the food chain from the farm, through distribution, retail and ultimately home or retail use. This capability will be highly valued in both established as well as emerging markets. Secondly, there are no burdensome chemical containers or tanks that continually need to be refilled and/or transported. Thirdly, the amount of disinfectant, such UV light and/or O₃ exposure, and oxygen level of the container can be controlled with no external intervention. Fourthly, the cost is quite reasonable. Finally, all byproducts of the process allowing for the discharge of the oxygen back into the environment is politically, commercially and environmentally correct, and very advantageous from a marketing and operational perspective. The details of one or more implementations are set forth in the accompanying drawings and the description below. Other features, objects, and advantages of the invention will be apparent from the description and drawings, and from the claims.

### DESCRIPTION OF DRAWINGS

FIG. 1 is an example food-preservation system with a UV source.

FIG. 2 is another example of a food preservation system with disinfectant.

FIG. 3 is yet another example of a food preservation system with disinfectant.

FIG. 4 is a flow chart illustrating an example method for preserving contents.

Like reference symbols in the various drawings indicate like elements.

### DETAILED DESCRIPTION

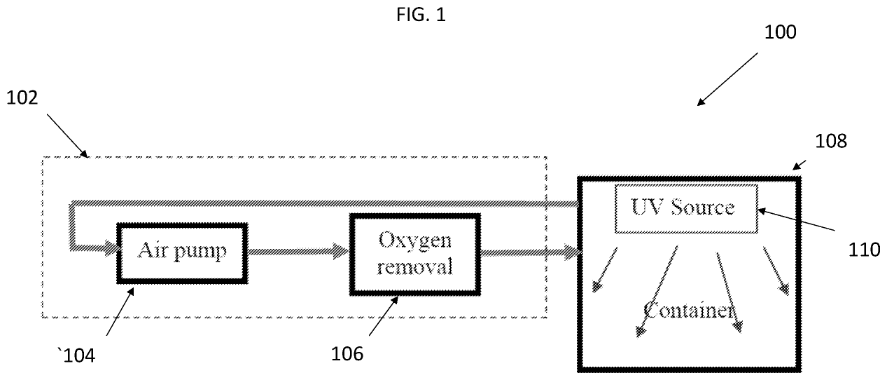

FIG. 1 illustrates a food preservation system 100 in accordance with some implementations of the present disclosure. In some implementations, the system 100 can generate a substantially inert gas and bacterial free or reduced environment. In these instances, the system 100 can slow the deterioration of the consumables that is not only cost effective but an efficient solution for oxygen removal and bacteria elimination from food, wine containers, and/or other consumables or consumable containers. The system 100 can be applied to any items (e.g., produce, clothes) adversely affected by the presence of oxygen and bacteria. A reduced oxygen environment can reduce mold, and its associated smell, and can reduce or eliminate insects from attacking the garment. In addition, anti-bacterial sources can further eliminate active or dormant bacteria. Before, at the onset, or during the procedure of removing the oxygen in the produce preservation process, exposure to ultraviolet (UV) light with sufficient intensity can greatly reduce the number of bacteria, or destroy them. As shown in the simplified drawing below, the container 108 for storing produce includes the UV source 110. The UV source 110 could be activated throughout the storage time continuously and/or intermittently to destroy bacteria. The illustrated system 100 can store, for example, ripened fruit and then reduce or remove the oxygen and exposing the interior of the container 108 to UV light to slow or prevent further ripening and spoilage. The UV source 110 may reduce or destroy bacteria in the air or on the surface of the contents.

As illustrated, the system 100 includes a circulating system 102 that extracts oxygen from air resulting in an inert gas or substantially inert gas in an atmospheric pressure environment. The circulating systems 102 includes a circulating pump 104 and a canister 106 filled with oxygen reducing material (one time disposable or rechargeable multi use material) from which the oxygen-reduced gas is pumped into the enclosed container 108, which includes, for example, food, bottled goods, clothes, or other items. As previously mentioned, the UV source 110 in the container 108 reduces or destroys bacteria. The gas from the container 108 is circulated through the air pump 104 and the oxygen removal 106 into the container 108, and UV source 110 exposes the specific container 108 to UV light. These processes may be continuous, intermittent (e.g., periodically) and/or in response to an event (e.g., insertion of the container 108). The system 100 include an oxygen reducing material, other techniques not yet known could be developed in the future and subsequently applied to the proposed system 100. These might be vacuum based or electric field based as examples. The UV source 110 may be any source of UV without departing from the scope of the disclosure.

The recirculation and UV exposure can provide multiple advantages. First, the oxygen removal in the container 108 will not be 100% efficient for any practical system. If only a portion of the oxygen is removed as it passes through the container 108, a lower limit of a final oxygen content in the container 108 can be set. In addition, the UV exposure may not destroy all bacteria and still provide a longer shelf life for consumables.

The system 100 can be closed to more efficiently use the oxygen absorbing material and reduce the introduction of additional bacteria. When recycling the gas through the canister 108, less oxygen is typically removed with each cycle. No matter how many times the cycle is performed, the amount of oxygen removed is from the original 20% of the container 108. That said, the container 108 may have insignificant leaks that contribute additional oxygen to the system 100. To be technically accurate, due to pressure equalization (final pressure of container to be approximately atmospheric), the amount of oxygen removed can equal to about 25% of the original volume of air. In addition, exposing the air and contents to UV light will reduce bacteria as long as the UV source 110 is active.

In some implementations, the oxygen removal material (ORM) can be rechargeable. In some instances, the ORM can be treated with perhaps heat or UV so that the oxygen is released and then the ORM is reused to remove oxygen again. In these instances, the recharging can occur within the system 100.

In some aspects of operation, the circulation system 102 removes air from the container 108 using the pump 104, which injects the removed air into the oxygen removal system 106. The pump 104 further injects the oxygen-reduced air into the container 108. The UV source 110 generates UV light in the container 108 to reduce or otherwise eliminate bacteria in the air and/or on the contents. While the UV source 110 is in the container 108, the UV source 110 may be located, for example, in the circulation system 102 prior to or after the oxygen removal 106 without departing from the scope of the disclosure. The UV source 110 may also be configured in parallel to the oxygen removal system 106.

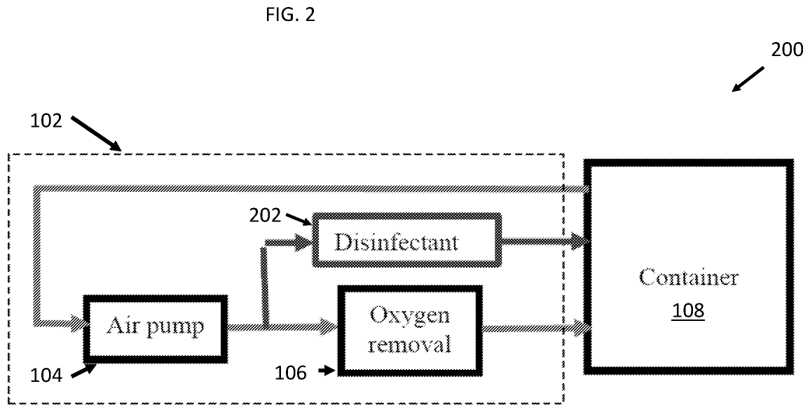

FIG. 2 is another example food preservation system 200 for food preservation including oxygen removal 106 and disinfectant 202. A typical means of destroying bacteria is through the use of chemicals, either in liquid or gaseous form. Well-known disinfectants such as those based on chlorine destroy bacteria but have an issue with residuals. A further complication is that the formation of these chemicals is typically somewhat complex. In many cases, additional chemicals from an external source would be required to remove the chemicals from the contents of the container 108. In contrast, the system 200 includes an ozone source 202 for disinfecting air injected into the container 108. While the ozone source 202 is located in the circulation system 102, the ozone source 202 may be located in the container 108 without departing from the scope of the disclosure.

A more favorable chemical is ozone (O₃) which has the advantage of breaking down into oxygen (O₂), which is obviously environmentally safe. Also, O₃ is quite active and at levels of only 10 parts per million (PPM) can destroy 99.9999% of the exposed bacteria in under 8 minutes. Such a small amount of O₃ with its half-life of 12 hours has almost no effect on the low oxygen concentration in the container. Typical oxygen levels of 0.5% used in the preservation process may only increase to 0.501% with the complete decay of all O₃ from an initial level of 10 PPM. Another advantage of O₃ is that it can be generated from the O₂ in the circulated air by subjecting the molecules to a strong electric field, which can be done very inexpensively. In other words, the disinfectant 202 may generate O₃ from existing O₂ in the system 200. While the disinfectant 202 operates in parallel to the oxygen removal 106, the disinfectant 202 may be located in serial with the oxygen removal 106 such as before or after.

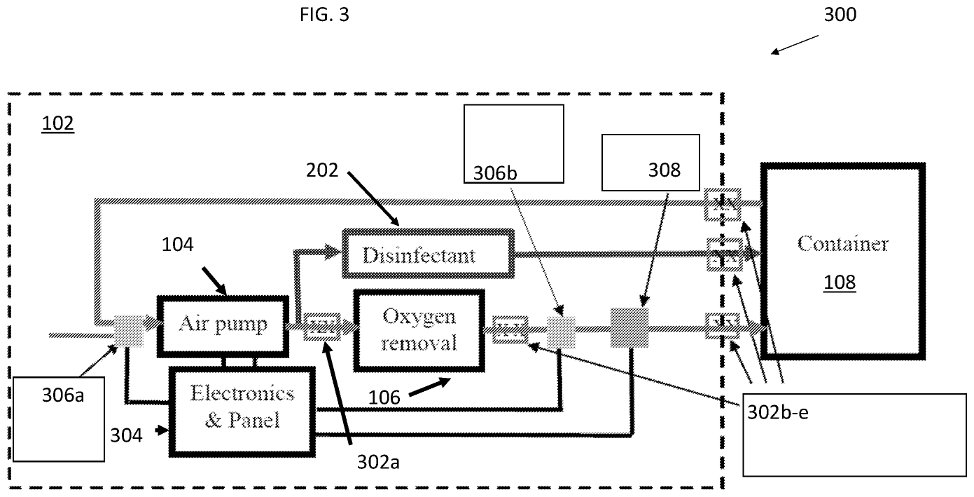

FIG. 3 is another example food preservation system 300 in some aspects of the present disclosure. As illustrated, the system 300 includes locking snap connectors 302a-e on the input and output of the container 108. Other connectors can be used without departing from the scope of the disclosure. In these instances, the recycling unit 102 can be quickly connected and disconnected to the container 108 or the disinfectant 202. The system 300 includes electronics 304 to control the operation (On/Off valve 308, timing, etc.) of the pump 104. One-way valves can be used in place of ON/OFF valves 308 or the snap connectors 302 can be also be used. As an example, a one-way valve can be used to allow air into the system 200 as the oxygen is removed. The cost of these items is typically less than $1. The current system 300 includes a low-pressure bleeder valves 306a-e. In addition, the circulation system 102 includes an O₃ generator 202 that injects O₃ into the container 108. While the O₃ generator 202 is illustrated inside the circulation system 102, the O₃ generator 202 may be located outside the circulation system 102 without departing from the scope of the disclosure.

Proper controls could be implemented in order to optimize performance of the system 300. As an example, the system 300 can be set to run for a given period of time. With different size containers, the operator can select a container size or simply allow the system 300 to run for extended periods of time (e.g., minutes, hours) to most or all the oxygen. The schemes presented are in no means the only way of introducing a disinfectant such O₃ into the food preservation container 108 but are only shown as examples. In some implementations, O₃ generator 202 along with the appropriate hardware would add less than $10 to the overall system 300.

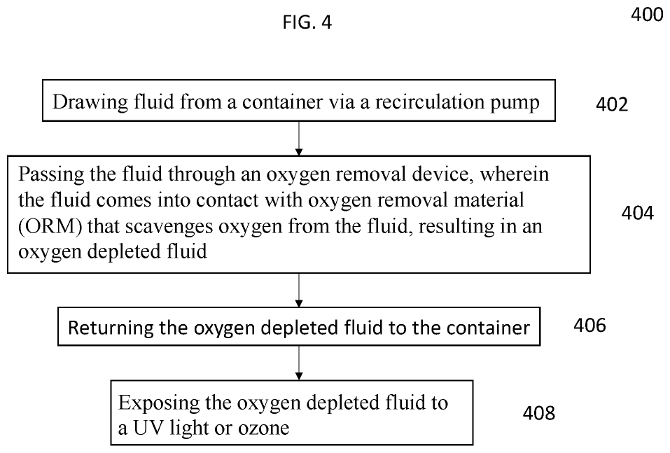

FIG. 4 illustrates an example flow chart 400 for preserving consumables in accordance with some implementations of the present disclosure. At step 402, fluid is drawn from a container using a recirculation pump. As illustrated in FIGS. 1-3, the air pump 104 draws or otherwise removes air from the container 108. At step 404, the oxygen is removed from the removed fluid. As illustrated in FIGS. 1-3, the oxygen removal 106 absorbs or otherwise removes oxygen from the circulated air. At step 406, the oxygen-depleted air is returned to the container. As illustrated in FIGS. 1-3, the oxygen-deleted air exits the oxygen removal 106 and returned to the container 108. At step 408, the oxygen-deleted air is exposed to UV light or ozone to eliminate, minimize, or otherwise reduce. As previously mentioned, oxygen removal and UV exposure may occur in the container 108, the circulation system 102, or both.

What is claimed is:

1. A system, comprising:
a container with an outlet fluidically connected to a recirculation pump and an inlet fluidically connected to an oxygen removal device;
the recirculation pump comprising an intake and a discharge, wherein the intake comprises a first connector, and the discharge is fluidically connected to the oxygen removal device; and
the oxygen removal device comprising:
an inlet fluidically connected to the discharge of the recirculation pump;
an outlet including a second connector;
oxygen removal material (ORM) embedded in the oxygen removal device and along a flowpath from the inlet to the outlet, wherein the ORM absorbs oxygen on contact; and
anti-bacterial system for destroying bacteria through the introduction of UV light or disinfectant.

2. The system of claim 1, wherein the first connector and second connector each comprise snap disconnects that prevent fluid flow when disconnected.

3. The system of claim 1, further comprising a low pressure bleeder valve fluidically connected to the inlet of the recirculation pump, wherein the low pressure bleeder valve is configured to introduce additional fluid into the system in response to a pressure in the system being below a predetermined threshold.

4. The system of claim 1, further comprising:
a first valve connected between the first connector and the recirculation pump;
a second valve connected between the second connector and the oxygen removal device;
a pressure sensor configured to sense a pressure in the system and generate a sensed pressure signal; and
a controller configured to open and close the first and second valves, and activate the recirculation pump based on a pressure signal from the pressure sensor.

5. The system of claim 1, further comprising:
an oxygen sensor configured to measure an oxygen concentration in the system.

6. The system of claim 1, wherein the ORM is a pyrogallol based material.

7. The system of claim 1, wherein the oxygen removal device further comprises:
an oxygen release system comprising:
a release path configured to permit fluid flow from the ORM out of the system; and
an energy source configured to impart energy on the ORM sufficient to cause the ORM to release scavenged oxygen.

8. The system of claim 7, wherein the energy source is ultraviolet light.

9. The system of claim 7, wherein the energy source is heat.

10. The system of claim 1 wherein, the system is integral to a containerized storage device, wherein the containerized storage device comprises one or more containers.

11. The system of claim 1 wherein the UV light is emitted in the container.

12. The system of claim 1 wherein the ozone is introduced in the.

13. The system of claim 12 wherein, an O₃ generator used in the system for the purpose of creating O₃ used subsequently in destroying bacteria.

14. A method for removing oxygen from a container while offering a means of destroying bacteria, the method comprising:
drawing fluid from the container via a recirculation pump;
passing the fluid through an oxygen removal device, wherein the fluid comes into contact with oxygen removal material (ORM) that scavenges oxygen from the fluid, resulting in an oxygen depleted fluid;
returning the oxygen depleted fluid to the container; and
exposing the fluid to a UV light or ozone.

15. The method of claim 14, further comprising:
in response to a pressure in the container falling below a predetermined amount, introducing new fluid to the container.

16. The method of claim 14, further comprising:
receiving an first pressure measurement associated with a pressure in the container;
determining a target pressure for the container associated with removing oxygen from the container;
opening one or more valves to allow fluid flow;
running the recirculation pump;
receiving a second pressure measurement associated with the pressure in the container;
in response to the second pressure measurement being equal to or less than the target pressure:
closing the one or more valves; and
stopping the recirculation pump.

17. The method of claim 14, further comprising:
determining a scavenging efficiency;
in response to the scavenging efficiency being below a predetermined threshold:
opening one or more valves to permit fluid flow from the ORM to an external area; and
exposing the ORM to an energy sufficient to cause the ORM to release scavenged oxygen.

18. The method of claim 17, wherein the energy is ultraviolet light.

19. The method of claim 17, wherein the energy is heat.

20. The method of claim 14, wherein the fluid comprises air, and wherein the container contains food to be preserved.

21. The method of claim 20, wherein the food is further preserved by reducing a temperature in the container.

22. The method of claim 14, wherein the ORM is a pyrogallol based material.

23. The method of claim 14, further comprising controlling a humidity within the container.

24. The method of claim 14, wherein the container is one of one or more containers that form a containerized storage device.

25. The method of claim 14 wherein, the UV light or ozone is introduced into to destroy bacteria.

26. A system, comprising:
a recirculation pump comprising an intake and a discharge, wherein the intake comprises a first connector, and the discharge is fluidically connected to an oxygen removal device;
the oxygen removal device comprising:
an inlet fluidically connected to the discharge of the recirculation pump;
an outlet including a second connector; and
an oxygen removal portion configured to remove oxygen from fluid passing from the inlet to the outlet; and
anti-bacterial system for destroying bacteria through introducing UV light or ozone.

27. The system of claim 26, wherein the first connector and second connector each comprise snap disconnects that prevent fluid flow when disconnected.

28. The system of claim 26, further comprising a low-pressure bleeder valve fluidically connected to the inlet of the recirculation pump, wherein the low pressure bleeder valve is configured to introduce additional fluid into the system in response to a pressure in the system being below a predetermined threshold.

29. The system of claim 26, further comprising:
a first valve connected between the first connector and the recirculation pump;
a second valve connected between the second connector and the oxygen removal device;
a pressure sensor configured to sense a pressure in the system and generate a sensed pressure signal; and
a controller configured to open and close the first and second valves, and activate the recirculation pump based on a pressure signal from the pressure sensor.

30. The system of claim 26, further comprising:
an oxygen sensor configured to measure an oxygen concentration in the system.

31. The system of claim 26, wherein the oxygen removal device further comprises:
an oxygen release system comprising:
a release path configured to permit fluid flow from the oxygen removal portion of the oxygen removal device out of the system; and
an energy source configured to impart energy on the oxygen removal portion of the oxygen removal device sufficient to cause the oxygen removal portion to release scavenged oxygen.

32. The system of claim 31, wherein the energy source is ultraviolet light.

33. The system of claim 31, wherein the energy source is heat.

34. The system of claim 31, wherein the energy source is electric field.

35. The system of claim 31, wherein the energy source is vacuum.

36. The system of claim 26, wherein the system is integral to a containerized storage device, wherein the containerized storage device comprises one or more containers.
